(19) United States
(12) Patent Application Publication
(10) Pub. No.: US 2026/0088897 A1
(43) Pub. Date: Mar. 26, 2026

(54) OPTICAL TRANSMISSION SYSTEM AND OPTICAL TRANSMISSION DEVICE

(71) Applicant: 1FINITY Inc., Kawasaki-shi (JP)

(72) Inventors: Yusaku YAMAMOTO, Kawasaki (JP); Takashi SATO, Kawasaki (JP)

(73) Assignee: 1FINITY Inc., Kawasaki-shi (JP)

(21) Appl. No.: 19/327,566

(22) Filed: Sep. 12, 2025

(30) Foreign Application Priority Data
Sep. 20, 2024 (JP) 2024-164087

(51) Int. Cl. H04B 10/077

(52) U.S. Cl. CPC H04B 10/0777

(57) ABSTRACT

An optical transmission system includes a first optical transmission device and a second optical transmission device facing each other via an optical transmission line. The first optical transmission device includes a first optical outputter that outputs first OSC light, a first pseudo light source that outputs first pseudo light including a wavelength band of first signal light, and a first transmitter that transmits first multiplexed light obtained by multiplexing the first OSC light and the first pseudo light toward the second optical transmission device. The second optical transmission device includes a second optical outputter that outputs second OSC light, a second pseudo light source that outputs second pseudo light including a wavelength band of second signal light, and a second transmitter that transmits second multiplexed light obtained by multiplexing the second OSC light and the second pseudo light toward the first optical transmission device.

### CROSS-REFERENCE TO RELATED APPLICATION

This application is based upon and claims the benefit of priority of Japanese Patent Application No. 2024-164087 filed on Sep. 20, 2024, the entire contents of which are incorporated herein by reference.

### FIELD

A certain aspect of the present embodiments relates to an optical transmission system and an optical transmission device.

### BACKGROUND

There has been known an optical transmission system that transmits wavelength division multiplexing (WDM) signal light including a plurality of optical signals having different wavelengths. In addition, there has been also known an optical transmission system that amplifies and repeats a signal light by an optical repeating device using an optical amplifier (for example, Japanese Application Patent Publication No. 2003-124889).

The optical transmission system includes an optical transmitter and an optical receiver. The optical transmitter and the optical receiver have the same function as one optical transmission device in practice. For example, an optical amplifier that amplifies and outputs signal light is provided in the optical transmission device. In addition, in the optical transmission system, an optical supervisory signal called an optical supervisory channel (OSC) is used for operation setting, state monitoring, and the like (for example, Japanese Application Patent Publication No. 2004-088376, U.S. patent Ser. No. 10/992,374, and U.S. Application Patent Publication No. 2006/0140626).

### SUMMARY

According to an aspect of the present disclosure, there is provided an optical transmission system including: a first optical transmission device and a second optical transmission device facing each other via an optical transmission line. The first optical transmission device includes: a first optical outputter that outputs first Optical Supervisory Channel (OSC) light; a first pseudo light source that outputs first pseudo light including a wavelength band of first signal light; and a first transmitter that transmits first multiplexed light obtained by multiplexing the first OSC light and the first pseudo light toward the second optical transmission device. The second optical transmission device includes: a second optical outputter that outputs second OSC light; a second pseudo light source that outputs second pseudo light including a wavelength band of second signal light; and a second transmitter that transmits second multiplexed light obtained by multiplexing the second OSC light and the second pseudo light toward the first optical transmission device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of an optical transmission system according to a first embodiment.

FIG. 2 is a flowchart illustrating an example of an operation of the optical transmission device according to the first embodiment.

FIG. 3 is a diagram illustrating an example of improvement in the intensity of OSC light.

FIG. 4 is a diagram illustrating an example of OSC link-up.

FIG. 5 illustrates an example of an optical transmission system according to a second embodiment.

FIG. 6 is a flowchart illustrating an example of an operation of the optical transmission device according to the second embodiment.

FIG. 7 is a diagram illustrating another example of improvement in the intensity of OSC light.

FIG. 8 illustrates an example of an optical transmission system according to a third embodiment.

FIG. 9 is a flowchart illustrating an example of an operation of the optical transmission device according to the third embodiment.

FIG. 10 illustrates an example of an optical transmission system according to a fourth embodiment.

FIG. 11 is a flowchart illustrating an example of an operation of an optical transmission device according to the fourth embodiment.

FIG. 12 is a flowchart illustrating an example of the operation of an optical repeating device according to the fourth embodiment.

FIG. 13A is a diagram illustrating a comparative example.

FIG. 13B is a diagram illustrating an embodiment.

FIG. 14 illustrates an example of an optical transmission system according to a fifth embodiment.

FIG. 15 is a flowchart illustrating an example of the operation of an optical transmission device according to the fifth embodiment.

FIG. 16 is a flowchart illustrating an example of the operation of an optical repeating device according to the fifth embodiment.

FIG. 17 is a diagram illustrating an example of an optical transmission system according to a sixth embodiment.

FIG. 18 is a flowchart illustrating an example of the operation of the optical transmission device according to the sixth embodiment.

FIG. 19 is a flowchart illustrating an example of the operation of an optical repeating device according to the sixth embodiment.

### DETAILED DESCRIPTION

An output level of the optical amplifier provided in the optical transmission device is determined based on a loss value of the optical transmission line interposed between the optical transmission devices facing each other at the time of activation of the optical transmission devices. The loss value of the optical transmission line is notified from one optical transmission device to the other optical transmission device by the above-described optical supervisory signal (hereinafter referred to as OSC light). This enables the optical transmission device to decide the output level of the optical amplifier. Therefore, at the time of activation of the optical transmission devices, at least communication of the OSC light is required between the optical transmission devices.

However, when the loss value of the optical transmission line is excessive, it becomes difficult to communicate the OSC light between the optical transmission devices depending on the intensity of the OSC light. In this case, the optical transmission device may not be able to check the communication of the OSC light.

Therefore, according to an aspect, an object is to provide an optical transmission system and an optical transmission device that improve the intensity of OSC light.

Hereinafter, embodiments of the present disclosure will be described with reference to the drawings.

### First Embodiment

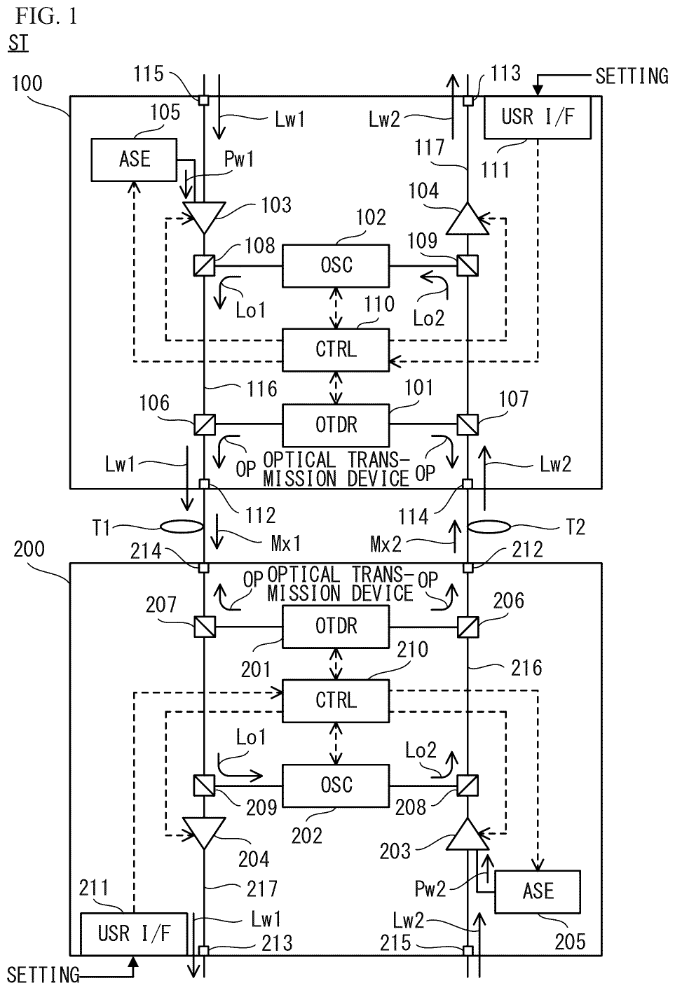

As illustrated in FIG. 1, an optical transmission system ST includes two optical transmission devices 100 and 200 facing each other. The optical transmission device 100 is an example of a first optical transmission device. The optical transmission device 200 is an example of a second optical transmission device. Each of the optical transmission devices 100 and 200 includes, for example, a reconfigurable optical add/drop multiplexer (ROADM).

The optical transmission devices 100 and 200 are connected to each other via two optical transmission lines T1 and T2 arranged in parallel. Both the optical transmission lines T1 and T2 include optical fibers. The type of the optical fiber is not particularly limited. The optical fiber may be a single mode fiber (SMF) or a dispersion shifted fiber (DSF).

First, the optical transmission device 100 will be described. The optical transmission device 100 includes an optical time domain reflectometer (OTDR) 101, an OSC input/output unit 102, and optical amplifiers 103 and 104. The OTDR 101 is an example of a pulse transceiver. The OSC input/output unit 102 is an example of a first optical outputter.

The optical transmission device 100 includes an ASE (Amplified Spontaneous Emission) light source 105, WDM couplers 106, 107 and 108, a branching coupler 109, and a controller 110 (denoted by CTRL in FIG. 1). The ASE light source 105 is an example of a first pseudo light source. The optical transmission device 100 further includes a user interface 111 (denoted as USR I/F in FIG. 1), optical transmitters 112 and 113, and optical receivers 114 and 115. The optical transmitter 112 is an example of a first transmitter. The optical receiver 114 is an example of a first optical receiver. The optical transmitters 112 and 113 and the optical receivers 114 and 115 include connectors, respectively.

The optical amplifier 103, the WDM couplers 106 and 108, the optical transmitter 112, and the optical receiver 115 are provided on an optical waveguide 116 of the optical transmission device 100. The optical amplifier 104, the WDM coupler 107, the branching coupler 109, the optical transmitter 113, and the optical receiver 114 are provided on an optical waveguide 117 of the optical transmission device 100.

The OTDR 101 is optically connected to the WDM couplers 106 and 107. The OTDR 101 transmits an optical pulse OP to the optical transmission lines T1 and T2 via the optical waveguides 116 and 117, and receives a reflected pulse of the optical pulse OP. The OTDR 101 receives the reflected pulse, thereby generating the optical power profiles of the optical transmission lines T1 and T2. Although details will be described later, the magnitude of the loss value of an optical transmission line T1 (hereinafter referred to as a span loss) and the span loss of an optical transmission line T2 are measured based on the optical power profiles generated by the OTDR 101, and the position of the loss occurrence of the optical power is estimated. Further, the connection state of the optical transmission lines T1 and T2, such as a connector disconnection, is measured based on the span loss of the optical transmission lines T1 and T2.

The OSC input/output unit 102 is optically connected to the WDM coupler 108 and the branching coupler 109. The OSC input/output unit 102 outputs OSC light Lo1 having an intensity (specifically, optical power) of about several dBm toward the optical transmission device 200. The OSC light Lo1 is an example of first OSC light. Since the intensity of the OSC light Lo1 is about several dBm, the adverse effect on WDM signal light Lw1 due to a nonlinear effect in the optical transmission line T1 is suppressed. The OSC light Lo1 may or may not include the span loss of the optical transmission line T1. OSC light Lo2 output from the optical transmission device 200 is input to the OSC input/output unit 102. The OSC light Lo2 may or may not include the span loss of the optical transmission line T2.

The optical amplifier 103 amplifies and outputs the WDM signal light Lw1 and pseudo light Pw1, which will be described later, received by the optical transmission device 100 via the optical receiver 115. The optical amplifier 103 is a post-amplifier realized by, for example, an erbium doped fiber amplifier (EDFA) and a circuit substrate that controls the gain of the EDFA. The post-amplifier is an amplifier provided in a subsequent stage or downstream of a wavelength selective switch (WSS) (not illustrated) provided between the optical amplifier 103 and the ASE light source 105. The WDM signal light Lw1 output from the optical amplifier 103 is transmitted to the optical transmission line T1 via the optical transmitter 112.

The optical amplifier 104 amplifies and outputs WDM signal light Lw2 and pseudo light Pw2, which will be described later, received by the optical transmission device 100 via the optical receiver 114. The optical amplifier 104 is a pre-amplifier realized by, for example, the EDFA and a circuit substrate that controls the gain of the EDFA. The pre-amplifier is an amplifier provided in a front stage or upstream of a WSS (not illustrated) provided between the optical amplifier 104 and the optical transmitter 113. The WDM signal light Lw2 output from the optical amplifier 104 is transmitted via the optical transmitter 113.

The ASE light source 105 is connected to the optical amplifier 103. More specifically, the ASE light source 105 is indirectly connected to the optical amplifier 103 via the above-described WSS. The ASE light source 105 outputs, for example, the pseudo light Pw1 called a Pseudo Wave. The pseudo light Pw1 includes a wavelength band of the WDM signal light Lw1, such as a C band (Conventional-band) and an L band (Long-wavelength-band). Note that the C band is a wavelength band from 1530 nm to 1565 nm, for example. The L band is, for example, a wavelength band from 1565 nm to 1625 nm.

The pseudo light Pw1 is amplified by the optical amplifier 103. After the amplification, the pseudo light Pw1 is multiplexed with the OSC light Lo1 by the WDM coupler 108. Thus, multiplexed light Mx1 obtained by multiplexing the OSC light Lo1 and the pseudo light Pw1 is generated. The multiplexed light Mx1 is an example of a first multiplexed light. The optical transmitter 112 transmits the multiplexed light Mx1 toward the optical transmission device 200. Thus, the multiplexed light Mx1 propagates through the optical transmission line T1.

The controller 110 is electrically connected to the OTDR101, the OSC input/output unit 102, the optical amplifiers 103 and 104, the ASE light source 105, and the user interface 111. The controller 110 includes a processor such as a central processing unit (CPU) and a memory such as a random access memory (RAM) or a read only memory (ROM). The controller 110 may include a field programmable gate array (FPGA) or an application specific integrated circuit (ASIC). The controller 110 controls the operations of the OTDR 101, the OSC input/output unit 102, the optical amplifiers 103 and 104, and the ASE light source 105.

For example, the controller 110 can request the OTDR 101 to transmit an optical pulse. The controller 110 can request the OSC input/output unit 102 to output the OSC light Lo1. The controller 110 can request the ASE light sources 105 to output the pseudo light Pw1. The controller 110 can adjust the gain of the optical amplifiers 103 and 104. In addition, the controller 110 can measure the connection state of the optical transmission lines T1 and T2 and the optical transmission device 100 based on the reflected pulse of the optical pulse as a measurer. The controller 110 can also measure the span loss of the optical transmission line T1, the span loss of the optical transmission line T2, the position of the loss occurrence of the optical power, and the like based on the optical power profiles generated by the OTDR 101.

The controller 110 acquires setting information including, for example, the span loss of the optical transmission line T1 from the user interface 111 at the time of starting the activation of the optical transmission device 100 before the operation of the optical transmission system ST is started. That is, the controller 110 acquires the setting information before the communication of the WDM signal light Lw1 and Lw2 is started. When the controller 110 determines that the span loss is excessive based on the setting information, the controller 110 switches the activation mode based on the setting of the activation mode from the user via the user interface 111. Specifically, the controller 110 determines that the span loss is excessive when the span loss is equal to or greater than a predetermined comparison target value. When the span loss is excessive, the controller 110 switches from a normal mode in which the pseudo light Pw1 is not output, to an extended mode in which the pseudo light Pw1 is output. In this manner, the controller 110 confirms the setting information and selects one of the normal mode and the extended mode based on the setting information. The normal mode is an example of a first mode, and the extended mode is an example of a second mode.

When the activation mode is switched to the extension mode, the controller 110 measures the connection state between the optical transmission device 100 and the optical transmission lines T1 and T2 based on the reflected pulse received by the OTDR 101. Specifically, the controller 110 measures whether the span loss excessive sections in which the span loss is excessive and the transmission line length is equal to or longer than the designated length are connected to the optical transmission device 100 as the optical transmission lines T1 and T2. Since the optical power of the OSC light Lo1 is low power of about several dBm and it is difficult to measure the connection state using the OSC light Lo1, the controller 110 measures the connection state between the optical transmission device 100 and the optical transmission lines T1 and T2 based on the reflected pulse.

Next, the optical transmission device 200 will be described. The optical transmission device 200 includes an OTDR 201, an OSC input/output unit 202, and optical amplifiers 203 and 204. The OTDR 201 is an example of a pulse transceiver. The OSC input/output unit 202 is an example of a second optical outputter. The optical transmission device 200 includes an ASE light source 205, WDM couplers 206, 207 and 208, a branching coupler 209, and a controller 210. The ASE light source 205 is an example of a second pseudo light source. The optical transmission device 200 further includes a user interface 211, optical transmitters 212 and 213, and optical receivers 214 and 215. The optical transmitter 212 is an example of a second transmitter. The optical receiver 214 is an example of a second optical receiver.

The optical amplifier 203, the WDM couplers 206 and 208, the optical transmitter 212, and the optical receiver 215 are provided on an optical waveguide 216 of the optical transmission device 200. The optical amplifier 204, the WDM coupler 207, the branching coupler 209, the optical transmitter 213, and the optical receiver 214 are provided on an optical waveguide 217 of the optical transmission device 200.

As described above, the optical transmission device 200 basically has the same configuration as that of the optical transmission device 100. Therefore, the details of the optical transmission device 200 are omitted. For example, the OSC input/output unit 202 outputs the OSC light Lo2 toward the optical transmission device 100. The OSC light Lo2 is an example of second OSC light. The ASE light source 205 outputs the pseudo light Pw2 including the wavelength band of the WDM signal light Lw2, such as the C band and the L band. The pseudo light Pw2 is an example of second pseudo light. The optical transmitter 212 transmits multiplexed light Mx2 obtained by multiplexing the OSC light Lo2 and the pseudo light Pw2 toward the optical transmission device 100. The multiplexed light Mx2 is an example of second multiplexed light. Thus, the multiplexed light Mx2 propagates through the optical transmission line T2. As described above, the controller 110 measures the connection state of the optical transmission lines T1 and T2 using the OTDR 101, but the controller 210 may measure the connection state of the optical transmission lines T1 and T2 using the OTDR 201.

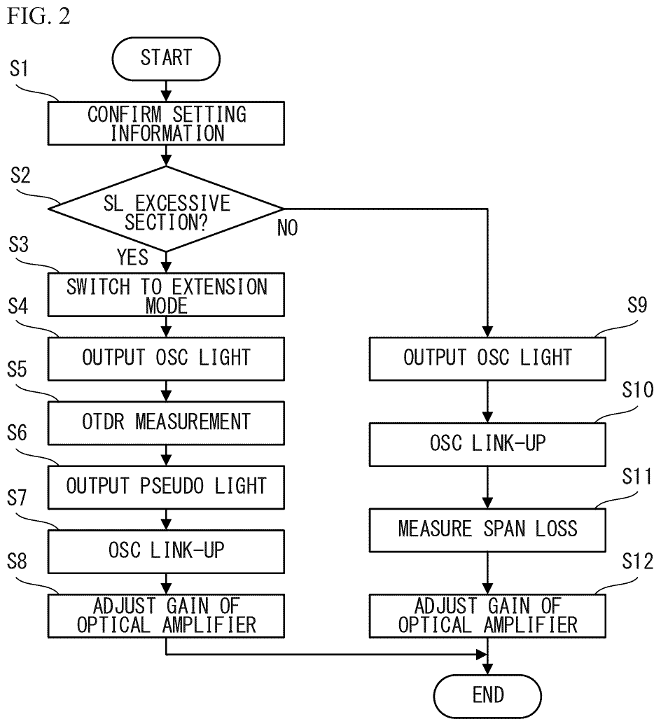

The operation of the optical transmission device 100 according to the first embodiment will be described with reference to FIGS. 2 to 4. The operation of the optical transmission device 200 according to the first embodiment is basically the same as the operation of the optical transmission device 100 according to the first embodiment, and thus detailed description thereof will be omitted.

When predetermined setting information is provided from the user to the optical transmission device 100, the controller 110 acquires and confirms the setting information (step S1). The setting information includes, for example, the span loss of the optical transmission line T1, a transmission line length of the optical transmission line T1, and the like. Before the process of step S1, the controller 110 may measure the span loss of the optical transmission line T1 based on the optical power profile as described above. When the setting information is confirmed, the controller 110 determines whether the optical transmission line T1 is a span loss excessive section (denoted as an SL excessive section in FIG. 2) based on the setting information (step S2).

When the optical transmission line T1 is the span loss excessive section (step S2: YES), the controller 110 switches the activation mode to the extension mode based on the setting of the activation mode from the user (step S3). When the mode is switched to the extension mode, the controller 110 requests the OSC input/output unit 102 to output the OSC light Lo1 (step S4). As a result, the OSC input/output unit 102 outputs the OSC light Lo1.

When the OSC light Lo1 is output, the controller 110 performs OTDR measurement (step S5). That is, the controller 110 requests the OTDR 101 to transmit the optical pulse OP. Thus, the OTDR 101 transmits the optical pulse OP, receives the reflected pulse, and generates the optical power profiles of the optical transmission lines T1 and T2. The controller 110 measures that the optical transmission lines T1 and T2 corresponding to the span loss excessive section are connected to the optical transmission device 100 based on the optical power profiles generated by the OTDR 101. That is, the controller 110 executes the OTDR measurement separately from the setting information, and measures the connection state of the optical transmission lines T1 and T2. The order of the process of steps S4 and S5 may be reversed.

When the OTDR measurement is performed, the controller 110 requests the ASE light source 105 to output the pseudo light Pw1. As a result, the ASE light source 105 outputs the pseudo light Pw1 (step S6). When the ASE light source 105 outputs the pseudo light Pw1, the optical amplifier 103 amplifies the pseudo light Pw1 (see FIG. 1). The pseudo light Pw1 amplified by the optical amplifier 103 propagates through the optical waveguides 116, and is multiplexed with the OSC light Lo1 by the WDM coupler 108. Thus, the multiplexed light Mx1 is generated. The multiplexed light Mx1 is transmitted from the optical transmitter 112 to the optical transmission line T1.

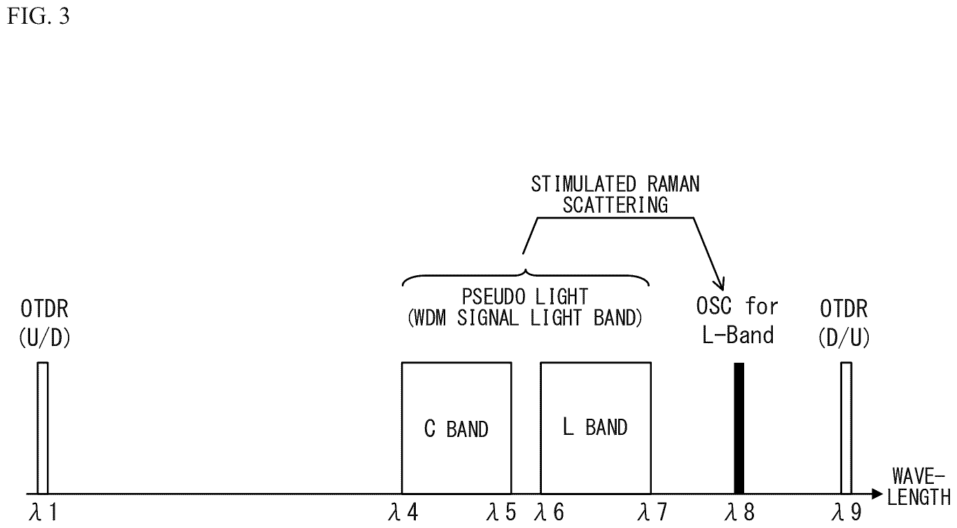

When the multiplexed light Mx1 is transmitted to the optical transmission line T1, stimulated Raman scattering occurs in the optical transmission line T1 as illustrated in FIG. 3. When the stimulated Raman scattering occurs, the optical power of the pseudo light Pw1 belonging to the multiplexed light Mx1 transits to the OSC light Lo1 having a wavelength λ8 longer than a maximum wavelength λ7 of the wavelength band of the pseudo light Pw1 due to the effect of the stimulated Raman scattering. This increases the optical power of the OSC light Lo1. That is, the intensity of the OSC light Lo1 is improved. In this way, by improving the intensity of the OSC light Lo1, even if the optical transmission line T1 corresponds to the span loss excessive section, the communication of the OSC light Lo1 between the optical transmission devices 100 and 200 is secured.

As illustrated in FIG. 3, the wavelength λ8 of the OSC light Lo1 is shorter than a wavelengths λ9 of the optical pulse OP of the OTDR 101 transmitted from the optical transmission device 100 on the downstream side to the optical transmission device 200 on the upstream side. On the other hand, a minimum wavelengths λ4 of the waveband of the pseudo light Pw1 is longer than the wavelength λ1 of the optical pulse OP of the OTDR 101 transmitted from the optical transmission device 100 on the upstream side to the optical transmission device 200 on the downstream side.

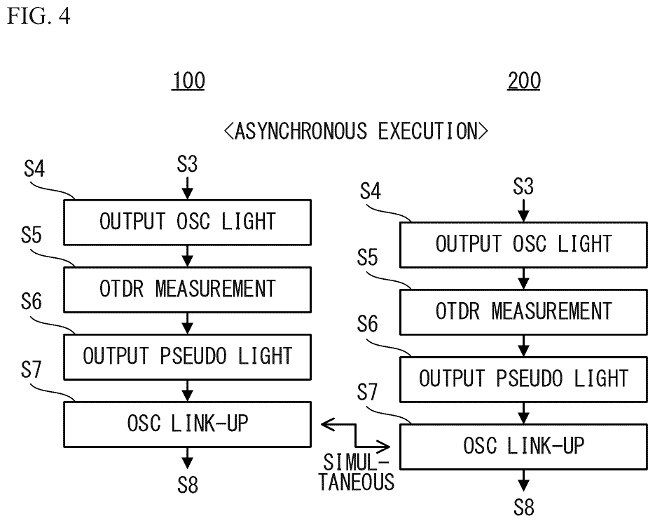

When the pseudo light Pw1 is output, the controller 110 determines the OSC link-up (step S7). The OSC link-up represents establishment of a communication link between the optical transmission device 100 and the optical transmission device 200 based on communication of the OSC light Lo1. More specifically, as illustrated in FIG. 4, the optical transmission device 200 asynchronously executes the same processing as that of the optical transmission device 100. Therefore, the OSC input/output unit 202 outputs the OSC light Lo2 and the ASE light sources 205 output the pseudo light Pw2, so that the optical transmission device 200 transmits the multiplexed light Mx2.

The optical transmission device 100 receives the multiplexed light Mx2 transmitted from the optical transmission device 200. The multiplexed light Mx2 propagates through the optical waveguide 117, and the OSC light Lo2 is demultiplexed from the multiplexed light Mx2 by the branching couplers 109. Thus, the OSC light Lo2 is input to the OSC input/output unit 102. Similarly, the optical transmission device 200 receives the multiplexed light Mx1 transmitted from the optical transmission device 100. The multiplexed light Mx1 propagates through the optical waveguide 217, and the OSC light Lo1 is demultiplexed from the multiplexed light Mx1 by the branching coupler 209. Thus, the OSC light Lo1 is input to the OSC input/output unit 202. In this way, when the OSC light Lo2 is input to the OSC input/output unit 102 and the OSC light Lo1 is input to the OSC input/output unit 202, the controllers 110 and 210 determines the OSC link-up at the same time, respectively.

When the OSC link-up is determined, the controller 110 adjusts the gain of the optical amplifiers 103 and 104 (step S8), and ends a startup process in the extension mode. As described above, the communication of the OSC light Lo1 and the OSC light Lo2 is secured by the OSC link-up. Therefore, the span loss of the optical transmission lines T1 and T2 is notified mutually between the optical transmission devices 100 and 200 by using the OSC light Lo1 and Lo2.

The controller 110 adjusts the gain of the optical amplifier 103 based on the span loss of the optical transmission line T1, and decides the power level of the optical amplifier 103. The controller 110 adjusts the gain of the optical amplifier 104 based on the span loss of the optical transmission line T2, and decides the power level of the optical amplifier 104. Similarly, the controller 210 adjusts the gain of the optical amplifier 203 based on the span loss of the optical transmission line T2, and decides the power level of the optical amplifier 203. The controller 210 adjusts the gain of the optical amplifier 204 based on the span loss of the optical transmission line T1, and decides the power level of the optical amplifier 204. Thus, when the operation of the optical transmission system ST is started, safe communication of the WDM signal light Lw1 and Lw2 is secured.

In the process of step S2 illustrated in FIG. 2, when the optical transmission line T1 is not the span loss excessive section (step S2: NO), the controller 110 maintains the normal mode without switching the activation mode to the extension mode. In this case, the controller 110 requests the OSC input/output unit 102 to output the OSC light Lo1. As a result, the OSC input/output unit 102 outputs the OSC light Lo1 (step S9).

When the OSC light Lo1 is output, the controller 110 determines the OSC link-up (step S10). Since the optical transmission line T1 is not the span loss excessive section, communication of the OSC light Lo1 and Lo2 is secured. When the OSC link-up is determined, the controller 110 measures the span loss of the optical transmission lines T1 and T2 by using the OSC light Lo1 and Lo2 (step S11). When the span loss is measured, the controller 110 adjusts the gain of the optical amplifier 103 based on the span loss of the optical transmission line T1 (step S12). When the controller 110 adjusts the gain of the optical amplifier 103 and decides the output level of the optical amplifier 103, the controller 110 ends the startup process in the normal mode. Note that the controller 210 performs the same process as the controller 110, and thus a detailed description thereof will be omitted.

As described above, according to the first embodiment, the intensity of the OSC light Lo1 is improved by the stimulated Raman scattering caused by the pseudo light Pw1. Similarly, the intensity of the OSC light Lo2 is improved by the stimulated Raman scattering caused by the pseudo light Pw2. Accordingly, even when the optical transmission lines T1 and T2 correspond to the span loss excessive section, the communication of the OSC light Lo1 and the OSC light Lo2 between the optical transmission devices 100 and 200 is secured.

### Second Embodiment

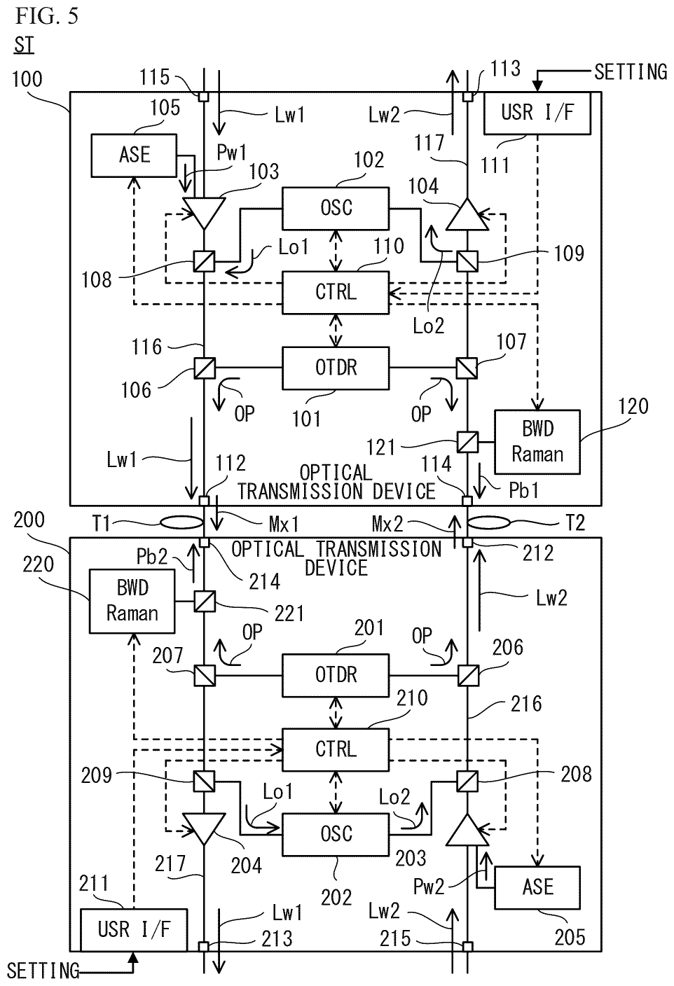

A second embodiment of the present disclosure will be described with reference to FIGS. 5 to 7. The same reference numerals are given to the same configurations and processes as those of the optical transmission devices 100 and 200 described in the first example embodiment, and detailed description thereof will be omitted.

First, as illustrated in FIG. 5, the optical transmission device 100 includes a backward pumping Raman amplifier 120 (denoted as BWD Raman in FIG. 5). The backward pumping Raman amplifier 120 is connected to the optical waveguide 117 via a WDM coupler 121. The optical transmission device 200 includes a backward pumping Raman amplifier 220. The backward pumping Raman amplifier 220 is connected to the optical waveguide 217 via a WDM coupler 221. Each of the backward pumping Raman amplifiers 120 and 220 is an example of a backward pumping light source.

The backward pumping Raman amplifier 120 outputs backward pumping light Pb1. The backward pumping light Pb1 propagates through the optical transmission line T2 in a direction opposite to the direction in which the multiplexed light Mx2 and the WDM signal light Lw2 propagate through the optical transmission line T2. The backward pumping light Pb1 Raman-amplifies the multiplexed light Mx2 by using the stimulated Raman scattering in the optical transmission line T2. Accordingly, the intensity of the OSC light Lo2 belonging to the multiplexed light Mx2 is further improved as compared with a case where the pseudo light Pw2 is used alone.

Similarly, the backward pumping Raman amplifier 220 outputs backward pumping light Pb2. The backward pumping light Pb2 propagates through the optical transmission line T1 in a direction opposite to the direction in which the multiplexed light Mx1 and the WDM signal light Lw1 propagate through the optical transmission line T1. The backward pumping light Pb2 Raman-amplifies the multiplexed light Mx1 by using the stimulated Raman scattering in the optical transmission line T1. Accordingly, the intensity of the OSC light Lo1 belonging to the multiplexed light Mx1 is further improved as compared with a case where the pseudo light Pw1 is used alone.

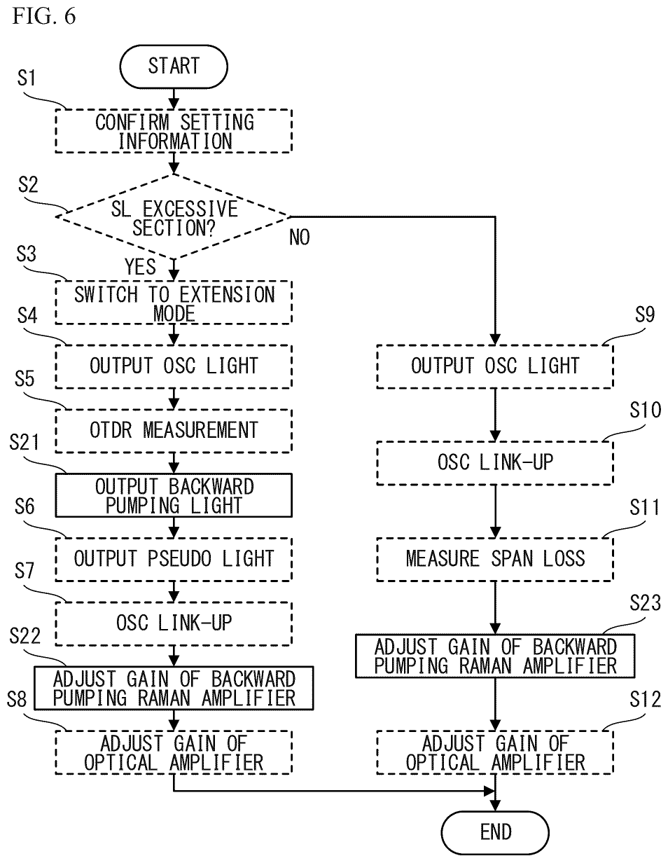

The operation of the optical transmission device 100 will be described. The operation of the optical transmission device 200 is basically the same as the operation of the optical transmission device 100, and thus the detailed description thereof will be omitted. As illustrated in FIG. 6, the controller 110 requests the backward pumping Raman amplifier 120 to output the backward pumping light Pb1 after the process of step S5 described in the first embodiment and before the process of step S6 (step S21). Thus, the backward pumping Raman amplifier 120 outputs the backward pumping light Pb1.

The controller 110 adjusts the gain of the backward pumping Raman amplifier 120 after the process of step S7 described in the first embodiment and before the process of step S8 (step S22). For example, the controller 110 adjusts the gain of the backward pumping Raman amplifier 120 based on the span loss of the optical transmission line T2 notified by using the OSC light Lo2 after the OSC link-up. Similarly, the controller 210 can adjust the gain of the backward pumping Raman amplifier 220 based on the span loss of the optical transmission line Lo1 notified by using the OSC light T1 after the OSC link-up.

Further, the controller 110 adjusts the gain of the backward pumping Raman amplifier 120 after the process of step S11 described in the first embodiment and before the process of step S12 (step S23). Similarly, the controller 210 can adjust the gain of the backward pumping Raman amplifier 220.

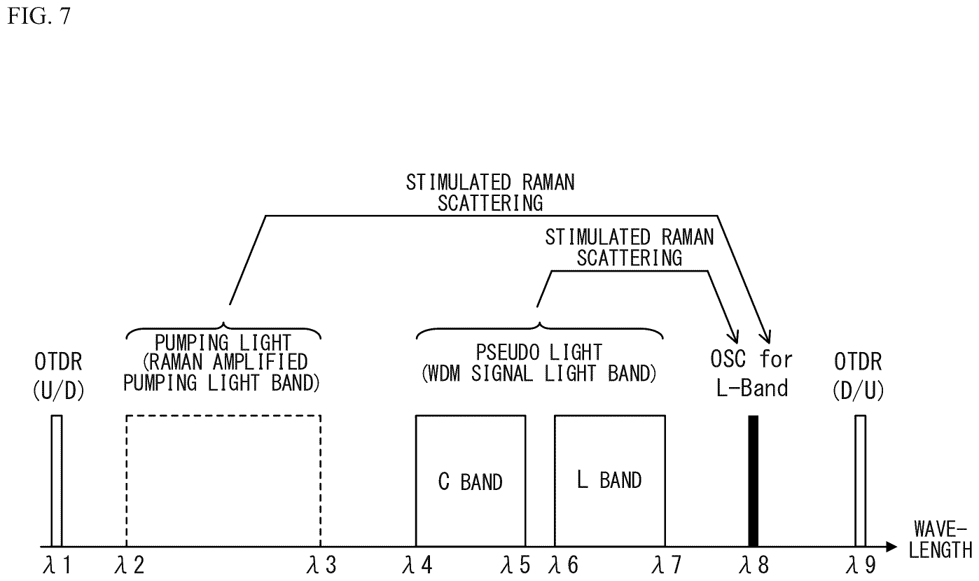

As described above, according to the second embodiment, the optical transmission device 100 includes the backward pumping Raman amplifier 120. This further improves the intensity of the OSC light Lo2 as compared with the case where the pseudo light Pw2 is used alone. Similarly, the optical transmission device 200 includes the backward pumping Raman amplifier 220. This further improves the intensity of the OSC light Lo1 as compared with the case where the pseudo light Pw1 is used alone. That is, as illustrated in FIG. 7, the OSC lights Lo1 and Lo2 can benefit not only from an effect of the stimulated Raman scattering from the pseudo light Pw1 and Pw2, but also from an effect of the stimulated Raman scattering from the backward pumping light Pb1 and Pb2 including a wavelength band from the minimum wavelength λ2 to the maximum wavelength λ3.

### Third Embodiment

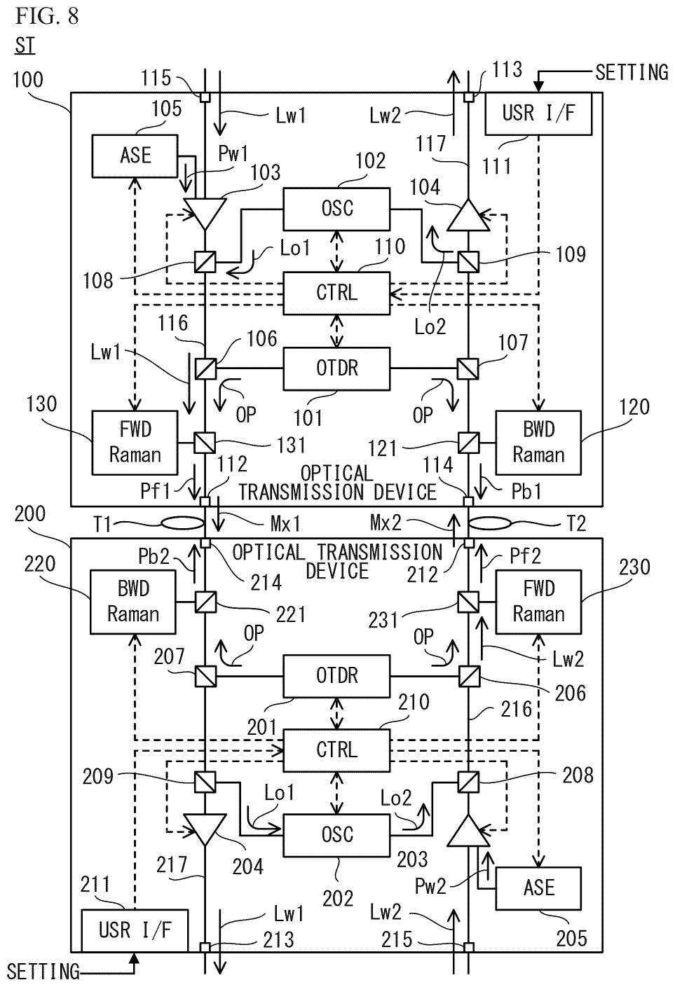

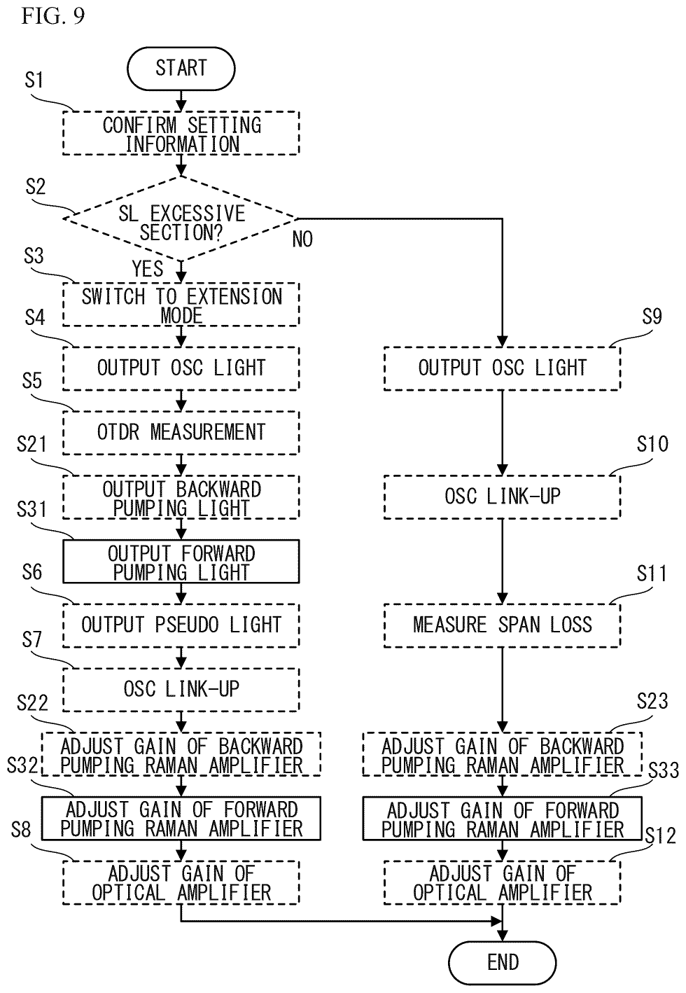

A third embodiment of the present disclosure will be described with reference to FIGS. 8 and 9. First, as illustrated in FIG. 8, the optical transmission device 100 according to the third embodiment is different from the optical transmission device 100 according to the second embodiment. Specifically, the optical transmission device 100 according to the third embodiment further includes a forward pumping Raman amplifier 130 (denoted as FWD Raman in FIG. 8). The forward pumping Raman amplifier 130 is connected to the optical waveguide 116 via a WDM coupler 131.

The optical transmission device 200 according to the third embodiment is different from the optical transmission device 200 according to the second embodiment. Specifically, the optical transmission device 200 according to the third embodiment further includes a forward pumping Raman amplifier 230. The forward pumping Raman amplifier 230 is connected to the optical waveguide 216 via a WDM coupler 231. Each of the forward pumping Raman amplifiers 130 and 230 is an example of a forward pumping light source.

The forward pumping Raman amplifier 130 outputs forward pumping light Pf1. The forward pumping light Pf1 propagates through the optical transmission line T1 in the same direction as the direction in which the multiplexed light Mx1 and the WDM signal light Lw1 propagate through the optical transmission line T1. The forward pumping light Pf1 Raman-amplifies the multiplexed light Mx1 by using the stimulated Raman scattering in the optical transmission line T1. Accordingly, the intensity of the OSC light Lo1 belonging to the multiplexed light Mx1 is further improved as compared with a case where the pseudo light Pw1 and the backward pumping light Pb2 are used together.

Similarly, the forward pumping Raman amplifier 230 outputs forward pumping light Pf2. The forward pumping light Pf2 propagates through the optical transmission line T2 in the same direction as a direction in which the multiplexed light Mx2 and the WDM signal light Lw2 propagate through the optical transmission line T2. The forward pumping light Pf2 Raman-amplifies the multiplexed light Mx2 by using the stimulated Raman scattering in the optical transmission line T2. Accordingly, the intensity of the OSC light Lo2 belonging to the multiplexed light Mx2 is further improved as compared with a case where the pseudo light Pw2 and the backward pumping light Pb1 are used together.

The operation of the optical transmission device 100 will be described. The operation of the optical transmission device 200 is basically the same as the operation of the optical transmission device 100, and thus the detailed description thereof will be omitted. As illustrated in FIG. 9, the controller 110 requests the forward pumping Raman amplifier 130 to output the forward pumping light Pf1 after the process of step S6 described in the second embodiment and before the process of step S21 (step S31). Thus, the forward pumping Raman amplifier 130 outputs the forward pumping light Pf1.

The controller 110 adjusts the gain of the forward pumping Raman amplifier 130 after the process of step S22 described in the second embodiment and before the process of step S8 (step S32). For example, the controller 110 adjusts the gain of the forward pumping Raman amplifier 130 based on the span loss of the optical transmission line T1 notified by using the OSC light Lo2 after the OSC link-up. Similarly, the controller 210 can adjust the gain of the forward pumping Raman amplifier 230 based on the span loss of the optical transmission line T2 notified by using the OSC light Lo1 after the OSC link-up.

Further, the controller 110 adjusts the gain of the forward pumping Raman amplifier 130 after the process of step S23 described in the second embodiment and before the process of step S12 (step S33). Similarly, the controller 210 can adjust the gain of the forward pumping Raman amplifier 230.

As described above, according to the third embodiment, the optical transmission device 100 includes the forward pumping Raman amplifier 130. This further improves the intensity of the OSC light Lo1 as compared with the case where the pseudo light Pw1 and the backward pumping light Pb2 are used together. Similarly, the optical transmission device 200 includes the forward pumping Raman amplifier 230. This further improves the intensity of the OSC light Lo2 as compared with the case where the pseudo light Pw2 and the backward pumping light Pb1 are used together. That is, the OSC light Lo1 and Lo2 can benefit not only from an effect of the stimulated Raman scattering from the pseudo light Pw1 and Pw2 and the backward pumping light Pb1 and Pb2, but also from an effect of the stimulated Raman scattering from the forward pumping light Pf1 and Pf2 including the wavelength band from the minimum wavelength λ2 to the maximum wavelength λ3.

### Fourth Embodiment

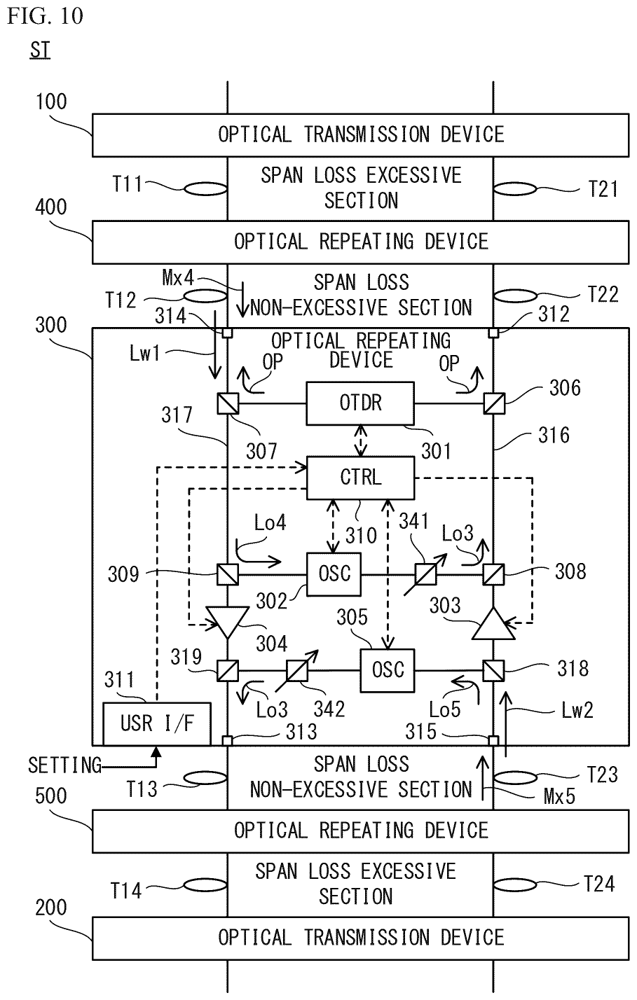

A fourth embodiment of the present disclosure will be described with reference to FIGS. 10 to 13. As illustrated in FIG. 10, the optical transmission system ST according to the fourth embodiment is different from the optical transmission system ST according to the first to third embodiments described above. Specifically, the optical transmission system ST according to the fourth embodiment includes optical repeating devices 300, 400 and 500. Each of the optical repeating devices 300, 400 and 500 is an example of a third optical transmission device. Each of the optical repeating devices 300, 400 and 500 includes, for example, an in-line amplifier (ILA).

The optical repeating devices 300 and 400 are connected to each other via two optical transmission lines T12 and T22 arranged in parallel. The optical repeating device 400 is connected to the optical transmission device 100 via two optical transmission lines T11 and T21 arranged in parallel. The optical repeating devices 300 and 500 are connected to each other via two optical transmission lines T13 and T23 arranged in parallel. The optical repeating device 500 is connected to the optical transmission device 200 via two optical transmission lines T14 and T24 arranged in parallel.

All of the optical transmission lines T11, T12, T13, T14, T21, T22, T23, and T24 include optical fibers. The type of the optical fiber is not particularly limited. The optical transmission lines T11, T21, T14, and T24 correspond to the span loss excessive sections described in the first embodiment. On the other hand, the optical transmission lines T12, T22, T13, and T23 correspond to span loss non-excessive sections. The span loss non-excessive section represents a normal section in which the span loss is not excessive. As described above, in the fourth embodiment, the plurality of span loss excessive sections and the plurality of span loss non-excessive sections are mixed.

The optical repeating device 300 includes an OTDR 301, an OSC input/output unit 302, and optical amplifiers 303 and 304. The optical repeating device 300 includes an OSC input/output unit 305, WDM couplers 306, 307 and 308, a branching coupler 309, and a controller 310.

The optical repeating device 300 further includes a user interface 311, optical transmitters 312 and 313, optical receivers 314 and 315, a branching coupler 318, a WDM coupler 319, and variable optical attenuators (VOA) 341 and 342. Each of the optical receivers 314 and 315 is an example of a receiver. As described above, the optical repeating device 300 does not include the above-described ASE light source. That is, the optical repeating device 300 cannot output the pseudo light. Therefore, the optical repeating device 300 cannot improve the intensity of the OSC light Lo3 described later by the pseudo light. Each of the optical repeating devices 400 and 500 has basically the same configuration as the optical repeating device 300, and thus detailed description thereof will be omitted.

The optical amplifier 303, the WDM couplers 306 and 308, the optical transmitter 312, the optical receiver 315, and the branching coupler 318 are provided on an optical waveguide 316 of the optical repeating device 300. The optical amplifier 304, the WDM couplers 307 and 319, the branching coupler 309, the optical transmitter 313, and the optical receiver 314 are provided on an optical waveguide 317 of the optical repeating device 300.

The OTDR 301 is optically connected to the WDM couplers 306 and 307. The OTDR 301 transmits the optical pulses OP to the optical transmission lines T12 and T22 via the optical waveguides 316 and 317, and receives the reflected pulses of the optical pulses OP. The OTDR 301 receives the reflected pulses, thereby generating the optical power profiles of the optical transmission lines T12 and T22. Based on the optical power profiles generated by the OTDR 301, the span loss of the optical transmission line T12, the span loss of the optical transmission line T22, the position of the loss occurrence of the optical power, and the like are measured. Further, the connection state of the optical transmission lines T12 and T22, such as a connector disconnection, is measured based on the span loss of the optical transmission lines T12 and T22.

The OSC input/output unit 302 is optically connected to the WDM coupler 308 and the branching coupler 309. The OSC input/output unit 302 outputs the OSC light Lo3 toward the optical repeating device 400. The OSC light Lo3 may or may not include the span loss of the optical transmission line T12. The OSC light Lo4 output from the optical repeating device 400 is input to the OSC input/output unit 302. The OSC light Lo4 may or may not include the span loss of the optical transmission line T22.

The OSC input/output unit 305 is optically connected to the WDM coupler 319 and the branching coupler 318. The OSC input/output unit 305 outputs the OSC light Lo3 toward the optical repeating device 500. The OSC light Lo3 may or may not include the span loss of the optical transmission line T23. The OSC light Lo5 output from the optical repeating device 500 is input to the OSC input/output unit 305. The OSC light Lo5 may or may not include span loss of the optical transmission line T13.

The optical amplifier 303 amplifies and outputs the WDM signal light Lw2 received by the optical repeating device 300 via the optical receiver 315 and the pseudo light Pw2 belonging to multiplexed light Mx5. The optical amplifier 303 is an amplifier realized by, for example, the EDFA and a circuit substrate that controls the gain of the EDFA. The WDM signal light Lw2 output from the optical amplifier 303 is transmitted to the optical transmission line T22 via the optical transmitter 312.

The optical amplifier 304 amplifies and outputs the WDM signal light Lw1 received by the optical repeating device 300 via the optical receiver 314 and the pseudo light Pw1 belonging to the multiplexed light Mx4. The optical amplifier 304 is an amplifier realized by, for example, the EDFA and the circuit substrate that controls the gain of the EDFA. The WDM signal light Lw1 output from the optical amplifier 304 is transmitted via the optical transmitter 313.

The controller 310 is electrically connected to the OTDR 301, the OSC input/output units 302 and 305, the optical amplifiers 303 and 304, and the user interface 311. Although not illustrated, the controller 310 is also electrically connected to the VOAs 341 and 342. Note that the hardware configuration of the controller 310 is basically the same as that of the controller 110, and thus a detailed description thereof will be omitted. The controller 310 controls the operations of the OTDR 301, the OSC input/output units 302 and 305, the optical amplifiers 303 and 304, and the VOAs 341 and 342.

For example, the controller 310 can request the OTDR 301 to transmit an optical pulse. The controller 310 can request the OSC input/output units 302 and 305 to output the OSC light Lo3. The controller 310 can adjust the gain of the optical amplifiers 303 and 304. The controller 310 can adjust the attenuation amounts of the VOAs 341 and 342. In addition, the controller 310 can measure the span loss of the optical transmission lines T12 and T22, the span loss of the optical transmission line T2, the position of the loss occurrence of the optical power, and the like based on the optical power profiles generated by the OTDR 301.

Further, the controller 310 acquires setting information including, for example, the span loss of the optical transmission lines T12, T13, T22, and T23 from the user interface 311 at the time of starting the activation of the optical repeating device 300 before the operation of the optical transmission system ST is started. That is, the controller 310 acquires the setting information before the communication of the WDM signal light Lw1 and Lw2 is started. When the controller 310 determines that the span loss is excessive based on the setting information, the controller 310 switches the activation mode based on the setting of the activation mode from the user via the user interface 311. Specifically, the controller 310 determines that the span loss is excessive when the span loss is equal to or greater than a predetermined comparison target value.

When the span loss is excessive, the controller 310 switches from a normal mode in which the predetermined section information is not output to the extension mode in which the predetermined section information is transferred from the downstream to the upstream. When the controller 310 receives the predetermined section information from the downstream side, the controller 310 switches from the normal mode in which the predetermined section information is not output to the extension mode in which the predetermined section information is transferred to the upstream. The predetermined section information is, for example, information indicating that there is a span loss excessive section downstream of the optical repeating device 300. When the activation mode is switched to the extension mode, the controller 310 measures the connection state between the optical repeating device 300 and the optical transmission lines T12 and T22 based on the reflected pulses received by the OTDR 301.

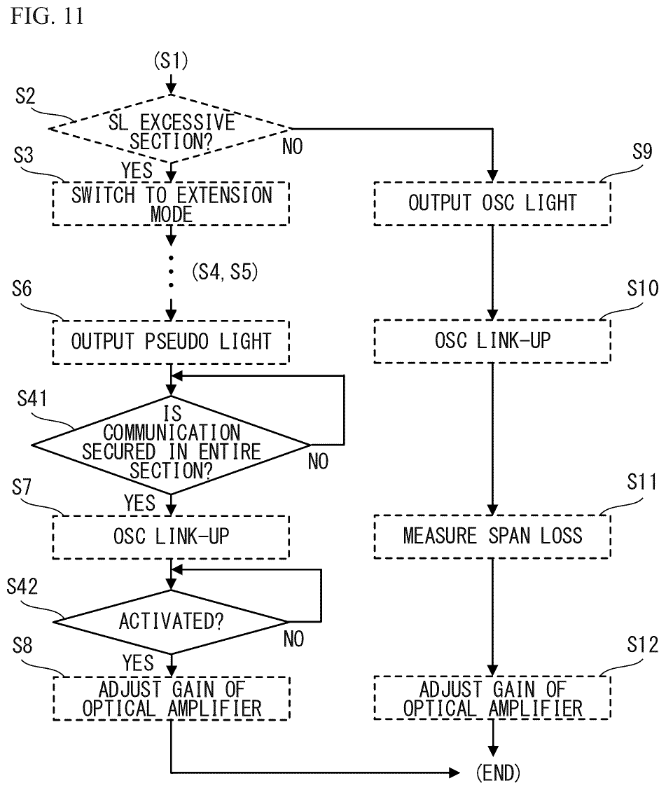

The operation of the optical transmission device 100 according to the fourth embodiment will be described with reference to FIG. 11. The operation of the optical transmission device 200 according to the fourth embodiment is basically the same as the operation of the optical transmission device 100 according to the fourth embodiment, and thus detailed description thereof will be omitted. In addition, the same reference numerals are given to the same processes as those of the optical transmission device 100 described in the first embodiment, and the detailed description thereof will be omitted.

The controller 110 executes the first determination process after the process of step S6 described in the first embodiment and before the process of step S7 (step S41). The first determination process is a process of waiting until the communication of the OSC light Lo1 to Lo5 is secured in the entire section from the optical transmission device 100 to the optical transmission device 200. The controller 110 executes the second determination process after the process of step S7 described in the first embodiment and before the process of step S8 (step S42). The second determination process is a process of waiting until the own route is activated.

That is, when the pseudo light Pw1 is output, the intensity of the OSC light Lo1 is improved, and thus, even when the optical transmission line T11 is a span loss excessive section (see FIG. 10), the communication of the OSC light Lo1 between the optical transmission device 100 and the optical repeating device 400 is secured. On the other hand, since the optical transmission line T12 is the span loss non-excessive section, the communication of the OSC light Lo4 between the optical repeating device 400 and the optical repeating device 300 is secured regardless of the presence or absence of the pseudo light. Further, since the optical transmission line T13 is also the span loss non-excessive section, the communication of the OSC light Lo3 between the optical repeating device 300 and the optical repeating device 500 is secured regardless of the presence or absence of the pseudo light.

However, when the optical transmission line T14 is the span loss excessive section, the optical repeating device 500 cannot output the pseudo light, and thus the intensity of the OSC light Lo5 is not improved, and the communication of the OSC light Lo5 between the optical repeating device 500 and the optical transmission device 200 is not secured and is inhibited. Therefore, the controller 110 waits until the communication of the OSC light Lo1 to Lo5 is secured in all the sections from the optical transmission device 100 to the optical transmission device 200 by the first determination processing (step S41: NO).

When the communication of the OSC light Lo1 to Lo5 is secured in all the sections (step S41: YES), the controller 110 waits until the own line is activated by the second determination processing (step S42: NO). That is, the controller 110 waits until the optical transmission line T11, which is the own line, is activated. When the own route is activated (step S42: YES), the controller 110 executes the process of step S8 and ends the process.

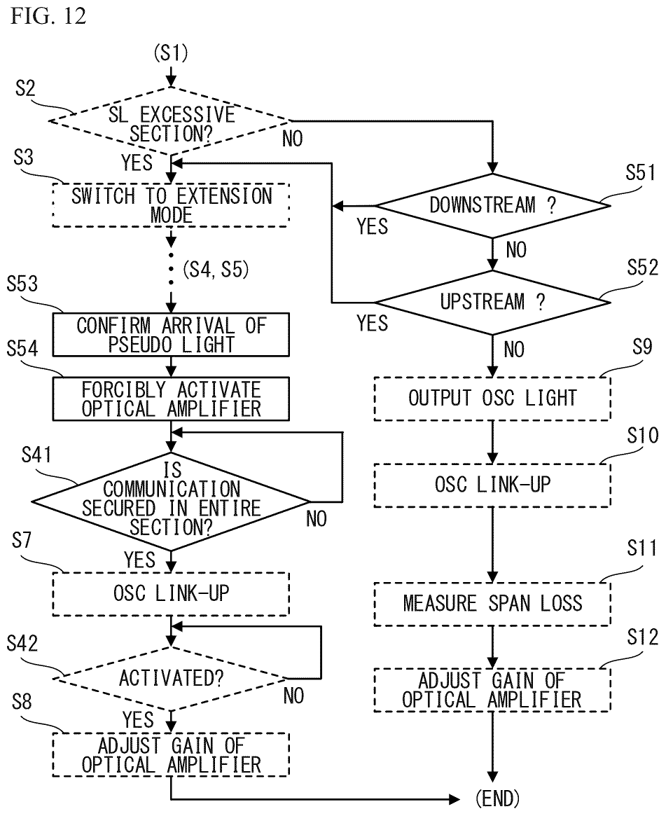

The operation of the optical repeating device 300 will be described with reference to FIG. 12. The operation of the optical repeating devices 400 and 500 according to the fourth embodiment is basically the same as the operation of the optical repeating device 300 according to the fourth embodiment, and thus detailed description thereof will be omitted.

Similarly to the process of step S2 described above, when the optical transmission lines T11, T12, T21, and T22 are not the span loss excessive sections, the controller 310 determines whether there is a span loss excessive section downstream of the optical repeating device 300 (step S51). For example, the controller 310 can determine whether there is an span loss excessive section downstream of the optical repeating device 300 based on the section information transferred from the optical repeating device 500.

When there is no span loss excessive section (step S51: NO), the controller 310 determines whether there is a span loss excessive section upstream of the optical repeating device 300 (step S52). For example, the controller 310 can determine whether there is a span loss excessive section upstream of the optical repeating device 300 based on the section information transferred from the optical repeating device 400. When there is no span loss excessive section (step S52: NO), the controller 310 executes the process of steps S9 to S12, and ends the process.

On the other hand, when there is a span loss excessive section (step S51: YES, S52: YES), the controller 310 performs the process of steps S3 to S5, and then confirms the arrival of the pseudo light (step S53). For example, the controller 310 confirms the arrival of the pseudo light Pw1 output from the optical repeating device 400. When the arrival of the pseudo light is confirmed, the controller 310 forcibly activates the optical amplifier 304 (step S54) and executes the subsequent process. Accordingly, the pseudo light Pw1 is output from the optical repeating device 400 to the optical repeating device 500.

That is, when the pseudo light Pw1 output from the optical transmission device 100 reaches the optical repeating device 400, a controller (not illustrated) of the optical repeating device 400 confirms the arrival of the pseudo light Pw1 and forcibly activates the optical amplifier. Accordingly, the pseudo light Pw1 is amplified and output from the optical repeating device 400 to the optical repeating device 300. The optical repeating device 300 also executes the same process. As a result, the pseudo light Pw1 is amplified and output from the optical repeating device 300 to the optical repeating device 500. In this way, the intensity of the OSC light Lo5 output from the optical repeating device 500 is improved due to the pseudo light Pw1. Therefore, even if the optical transmission line T14 is the span loss excessive section, the communication of the OSC light Lo5 between the optical repeating device 500 and the optical transmission device 200 is secured.

Therefore, even when the optical transmission system ST includes the plurality of optical repeating devices 300, 400 and 500, and the plurality of span loss excessive sections and the plurality of span loss non-excessive sections are mixed, the communication of the OSC light Lo1 to Lo5 including the span loss is secured in all the sections. Accordingly, the optical transmission devices 100 and 200 can adjust the gain of the optical amplifiers 103 and 204 based on the span loss. The optical repeating device 300 can adjust the gain of the optical amplifier 304 based on the span loss. The optical repeating devices 400 and 500 can also adjust the gain of the optical amplifier, similarly to the optical repeating device 300.

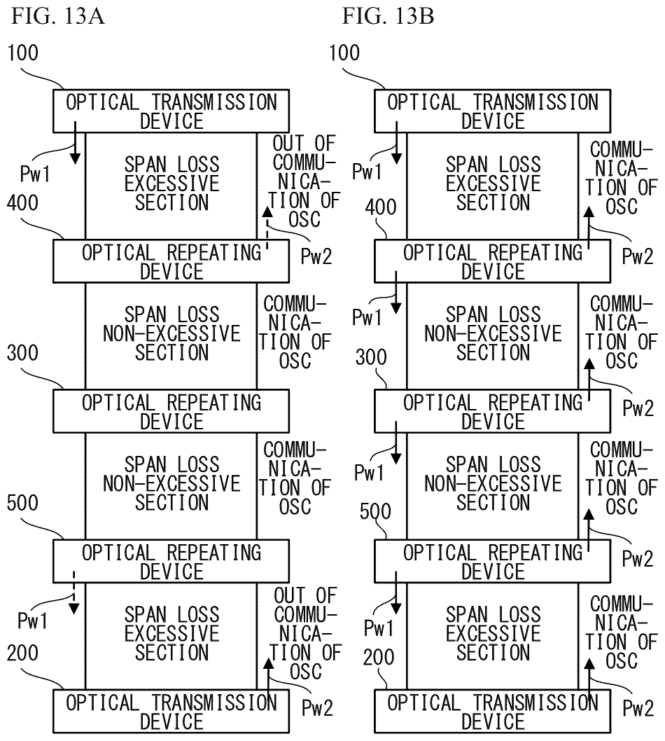

With reference to FIGS. 13A and 13B, an embodiment will be described in comparison with a comparative example.

First, in the comparative example, as illustrated in FIG. 13A, even when the pseudo light Pw1 is output from the optical transmission device 100, the optical repeating device 400 does not switch the activation mode to the extension mode, and thus the output of the pseudo light Pw1 from the optical repeating device 400 is interrupted. Similarly, the output of the pseudo light Pw1 is interrupted for the optical repeating devices 300 and 500 disposed downstream of the optical repeating device 400. This hinders the communication of the OSC light Lo2 and the OSC light Lo5 between the optical repeating device 500 and the optical transmission device 200. Even when the pseudo light Pw2 is output from the optical transmission device 200, similarly, the communication of the OSC light Lo1 and Lo4 between the optical repeating device 400 and the optical transmission device 100 is hindered.

However, in the embodiment, as illustrated in FIG. 13B, when the pseudo light Pw1 is output from the optical transmission device 100, the optical repeating device 400 switches the activation mode to the extension mode based on the section information transferred from the optical repeating device 300. Accordingly, the optical repeating device 400 can output the pseudo light Pw1. Similarly, the optical repeating device 300 switches the activation mode to the extension mode based on the section information transferred from the optical repeating device 500. Accordingly, the optical repeating device 300 can output the pseudo light Pw1.

The optical repeating device 500 switches the activation mode to the extension mode based on its own section information. Accordingly, the optical repeating device 500 can output the pseudo light Pw1. As a result, the communication of the OSC light Lo2 and Lo5 between the optical repeating device 500 and the optical transmission device 200 is secured. Similarly, the communication of the OSC light Lo1 and Lo4 between the optical repeating device 400 and the optical transmission device 100 is also secured.

### Fifth Embodiment

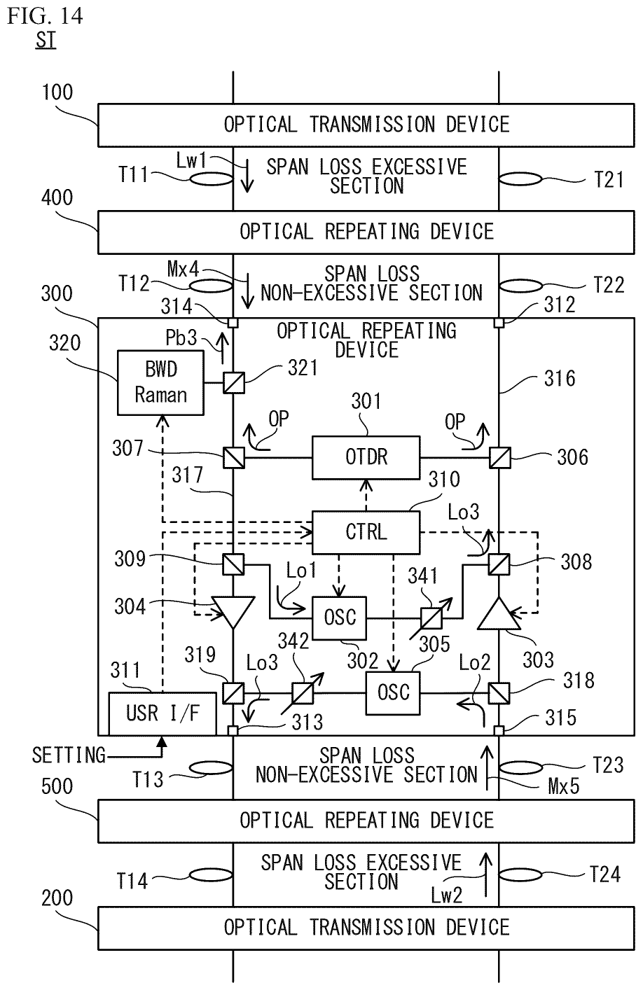

A fifth embodiment of the present disclosure will be described with reference to FIGS. 14 to 16. The same reference numerals are given to the same configurations and processes as those of the optical repeating device 300 described in the fourth example embodiment, and detailed description thereof will be omitted. Each of the optical repeating devices 400 and 500 has the same configuration and the same process as the optical repeating device 300, and thus the detailed description thereof will be omitted.

First, as illustrated in FIG. 14, the optical repeating device 300 includes a backward pumping Raman amplifier 320. The backward pumping Raman amplifier 320 is an example of a third optical outputter. The backward pumping Raman amplifier 320 is connected to the optical waveguide 317 via a WDM coupler 321. The backward pumping Raman amplifier 320 outputs backward pumping light Pb3. The backward pumping light Pb3 propagates through the optical transmission line T12 in a direction opposite to the direction in which the WDM signal light Lw1 propagates through the optical transmission line T12. The backward pumping light Pb3 Raman-amplifies the multiplexed light Mx4 output from the optical repeating device 400 in the optical transmission line T12 by using the stimulated Raman scattering. Accordingly, the intensity of the OSC light Lo4 belonging to the multiplexed light Mx4 is further improved as compared with the case where the pseudo light Pw1 is used alone.

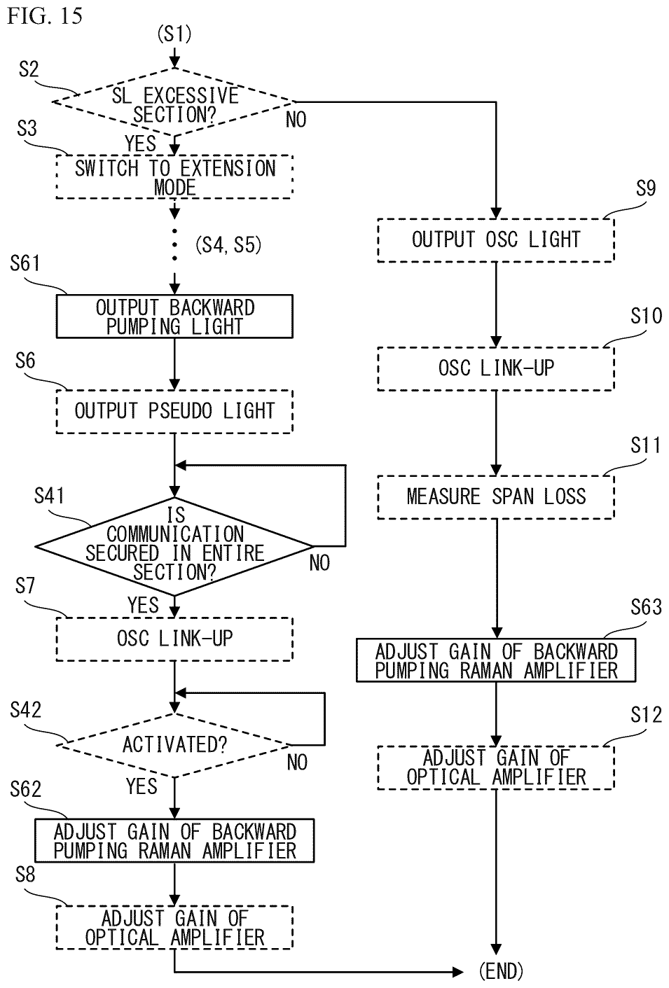

The operation of the optical transmission device 100 according to the fifth embodiment will be described with reference to FIG. 15. The operation of the optical transmission device 200 according to the fifth embodiment is basically the same as the operation of the optical transmission device 100 according to the fifth embodiment, and thus detailed description thereof will be omitted.

The controller 110 requests the backward pumping Raman amplifier 120 to output the backward pumping light Pb1 after the process of step S5 described in the first embodiment and before the process of step S6 (step S61). Thus, the backward pumping Raman amplifier 120 outputs the backward pumping light Pb1.

Further, the controller 110 adjusts the gain of the backward pumping Raman amplifier 120 after the process of step S42 described in the fourth embodiment and before the process of step S8 (step S62). After adjusting the gain of the backward pumping Raman amplifier 120, the controller 110 executes the subsequent process and ends the process.

Further, the controller 110 adjusts the gain of the backward pumping Raman amplifier 120 after the process of step S11 described in the first embodiment and before the process of step S12 (step S63). After adjusting the gain of the backward pumping Raman amplifier 120, the controller 110 executes the subsequent process and ends the process.

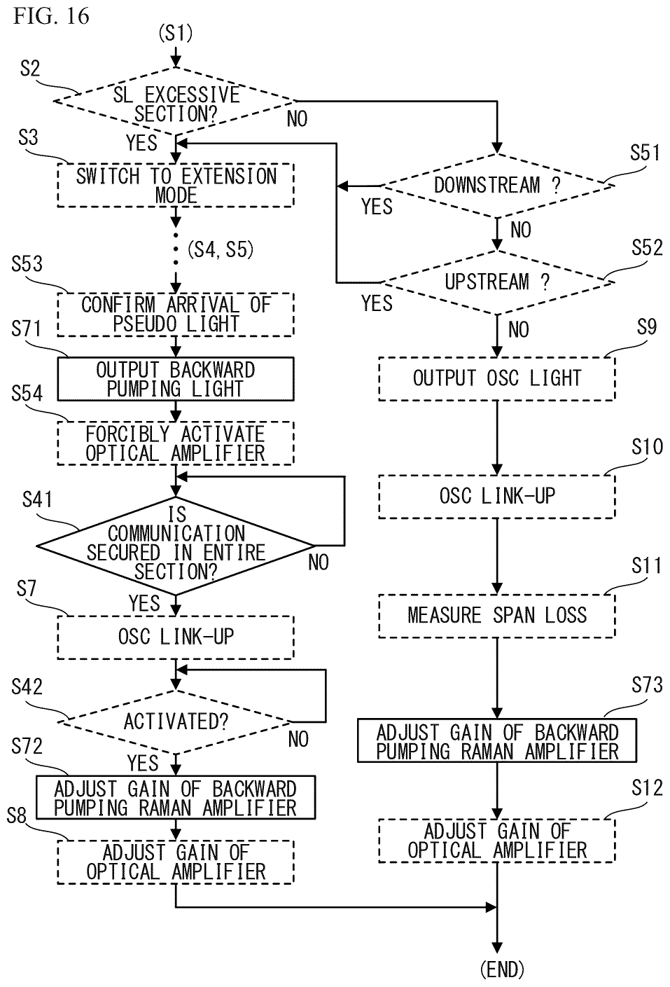

The operation of the optical repeating device 300 according to the fifth embodiment will be described with reference to FIG. 16. The operation of the optical repeating devices 400 and 500 according to the fifth embodiment is basically the same as the operation of the optical repeating device 300 according to the fifth embodiment, and thus detailed description thereof will be omitted.

After the process of step S53 described in the fourth embodiment and before the process of step S54, the controller 310 requests the backward pumping Raman amplifier 320 to output the backward pumping light Pb3 (step S71). Thus, the backward pumping Raman amplifier 320 outputs the backward pumping light Pb3.

The controller 310 adjusts the gain of the backward pumping Raman amplifier 320 after the process of step S42 and before the process of step S8 (step S72). After adjusting the gain of the backward pumping Raman amplifier 320, the controller 310 executes the subsequent process and ends the process. Further, the controller 310 adjusts the gain of the backward pumping Raman amplifier 320 after the process of step S11 and before the process of step S12 (step S73). After adjusting the gain of the backward pumping Raman amplifier 320, the controller 310 executes the subsequent process and ends the process.

As described above, according to the fifth embodiment, the optical repeating device 300 outputs the backward pump light Pb3, thereby improving the intensity of the multiplexed light Mx4. The optical repeating devices 400 and 500 can also improve the intensity of the multiplexed light, similarly to the optical repeating device 300. Accordingly, even when the plurality of span loss excessive sections and the plurality of span loss non-excessive sections are mixed in the optical transmission system ST, the communication of the OSC light Lo1 to Lo5 including the span loss is secured in all the sections.

### Sixth Embodiment

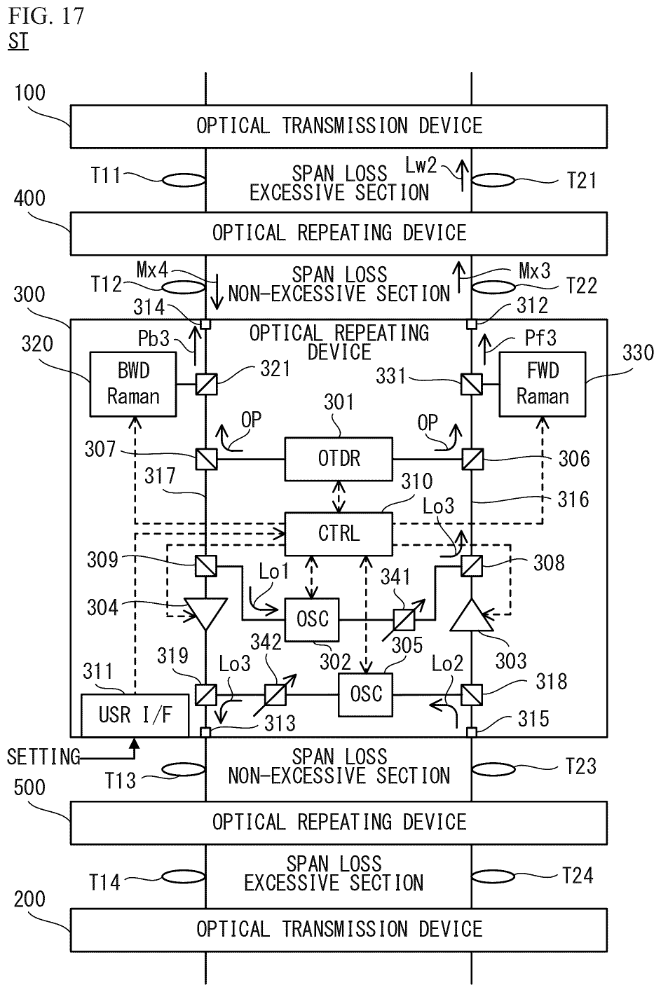

A sixth embodiment of the present disclosure will be described with reference to FIGS. 17 to 19. The same reference numerals are given to the same configurations and processes as those of the optical repeating device 300 described in the fifth embodiment, and the detailed description thereof will be omitted. Each of the optical repeating devices 400 and 500 has the same configuration as the optical repeating device 300, and thus the detailed description thereof will be omitted.

First, as illustrated in FIG. 17, the optical repeating device 300 includes a forward pumping Raman amplifier 330. The forward pumping Raman amplifier 330 is an example of a fourth optical outputter. The forward pumping Raman amplifier 330 is connected to the optical waveguide 316 via a WDM coupler 331. The forward pumping Raman amplifier 330 outputs forward pumping light Pf3. The forward pumping light Pf3 propagates through the optical transmission line T22 in the same direction as the direction in which the WDM signal light Lw2 propagates through the optical transmission line T22. The forward pumping light Pf3 Raman-amplifies the multiplexed light Mx3 output from the optical repeating device 300 in the optical transmission line T22 by using stimulated Raman scattering. Accordingly, the intensity of the OSC light Lo3 belonging to the multiplexed light Mx3 is further improved as compared with a case where the pseudo light Pw2 and the backward pump light output from the optical repeating device 400 are used together.

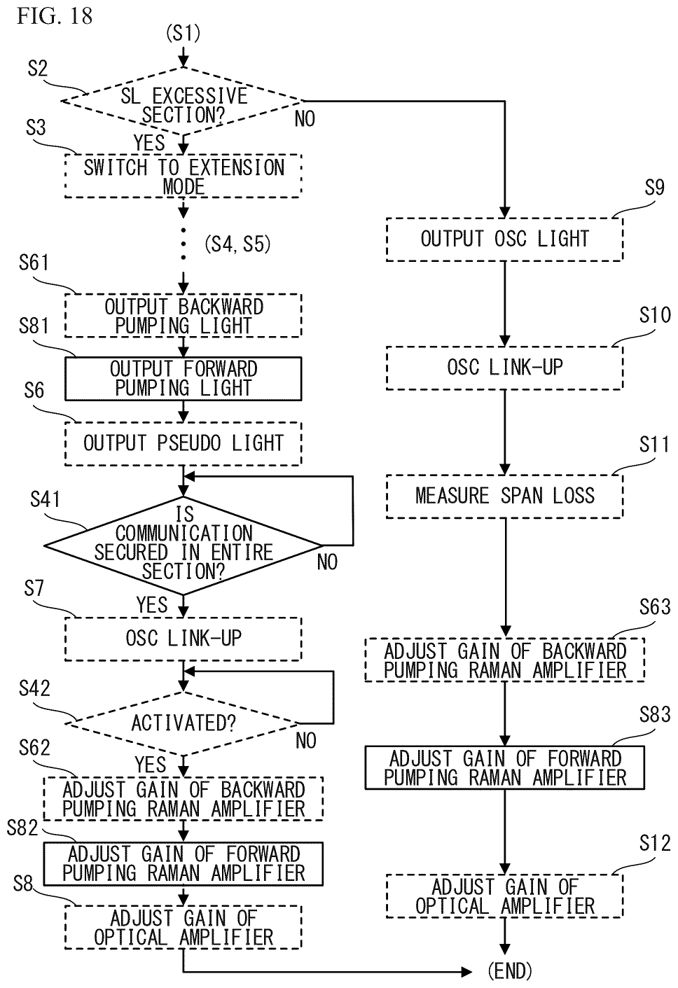

The operation of the optical transmission device 100 according to the sixth embodiment will be described with reference to FIG. 18. The operation of the optical transmission device 200 according to the sixth embodiment is basically the same as the operation of the optical transmission device 100 according to the sixth embodiment, and thus detailed description thereof will be omitted.

After the process of step S61 described in the fifth embodiment and before the process of step S6, the controller 110 requests the forward pumping Raman amplifier 130 to output the forward pumping light Pf1 (step S81). Thus, the forward pumping Raman amplifier 130 outputs the forward pumping light Pf1.

The controller 110 adjusts the gain of the forward pumping Raman amplifier 130 after the process of step S62 and before the process of step S8 (step S82). After adjusting the gain of the forward pumping Raman amplifier 130, the controller 110 executes the subsequent process and ends the process. Further, the controller 110 adjusts the gain of the forward pumping Raman amplifier 130 after the process of step S63 and before the process of step S12 (step S83). After adjusting the gain of the forward pumping Raman amplifier 130, the controller 110 executes the subsequent process and ends the process.

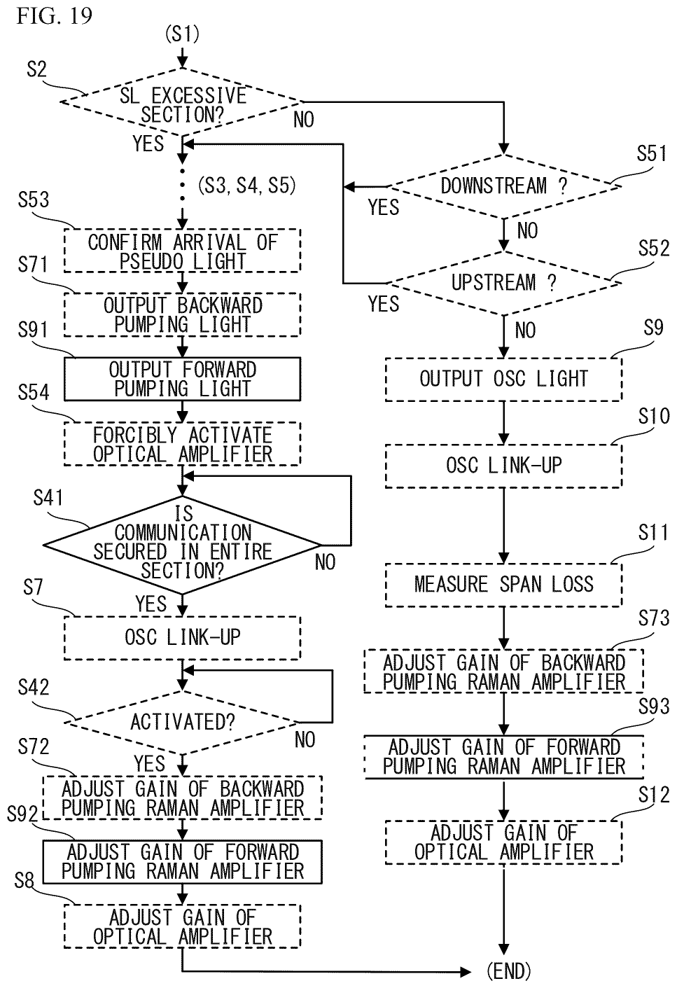

The operation of the optical repeating device 300 according to the sixth embodiment will be described with reference to FIG. 19. The operation of the optical repeating devices 400 and 500 according to the sixth embodiment is basically the same as the operation of the optical repeating device 300 according to the sixth embodiment, and thus detailed description thereof will be omitted.

After the process of step S71 and before the process of step S54, the controller 310 requests the forward pumping Raman amplifier 330 to output the forward pumping light Pf3 (step S91). Thus, the forward pumping Raman amplifier 330 outputs the forward pumping light Pf3.

The controller 310 adjusts the gain of the forward pumping Raman amplifier 330 after the process of step S72 and before the process of step S8 (step S92). After adjusting the gain of the forward pumping Raman amplifier 330, the controller 310 executes the subsequent process and ends the process. Further, the controller 310 adjusts the gain of the forward pumping Raman amplifier 330 after the process of step S73 and before the process of step S12 (step S93). After adjusting the gain of the forward pumping Raman amplifier 330, the controller 310 executes the subsequent process and ends the process.

As described above, according to the sixth embodiment, the optical repeating device 300 outputs the forward pumping light PB, thereby improving the intensity of the multiplexed light Mx3. The optical repeating devices 400 and 500 can also improve the intensity of the multiplexed light, similarly to the optical repeating device 300. Accordingly, even when the plurality of span loss excessive sections and the plurality of span loss non-excessive sections are mixed in the optical transmission system ST, the communication of the OSC light Lo1 to Lo5 including the span loss is secured in all the sections.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. In the above-described embodiment, the use of both the backward pumping Raman amplifiers 120 and 220 and the use of both the backward pumping Raman amplifiers 120 and 220 and the forward pumping Raman amplifiers 130 and 230 are described as an example, but the present disclosure is not limited to such use. For example, both the forward pumping Raman amplifiers 130 and 230 may be used without using the backward pumping Raman amplifiers 120 and 220. Similarly, although the single use of the backward pumping Raman amplifier 320 and the combined use of the backward pumping Raman amplifier 320 and the forward pumping Raman amplifier 330 are described as examples, the present disclosure is not limited to such uses. For example, the forward pumping Raman amplifier 330 may be used alone without using the backward pumping Raman amplifier 320.

What is claimed is:

1. An optical transmission system comprising:
a first optical transmission device and a second optical transmission device facing each other via an optical transmission line,
wherein the first optical transmission device includes:
a first optical outputter that outputs first Optical Supervisory Channel (OSC) light;
a first pseudo light source that outputs first pseudo light including a wavelength band of first signal light; and
a first transmitter that transmits first multiplexed light obtained by multiplexing the first OSC light and the first pseudo light toward the second optical transmission device, and
wherein the second optical transmission device includes:
a second optical outputter that outputs second OSC light;
a second pseudo light source that outputs second pseudo light including a wavelength band of second signal light; and
a second transmitter that transmits second multiplexed light obtained by multiplexing the second OSC light and the second pseudo light toward the first optical transmission device.

2. The optical transmission system according to claim 1,
wherein the first optical transmission device includes a first optical receiver that receives the second multiplexed light from the second optical transmission device, the second optical transmission device includes a second optical receiver that receives the first multiplexed light from the first optical transmission device, and
wherein when the second optical receiver receives the first multiplexed light and the second optical outputter detects the first OSC light demultiplexed from the first multiplexed light in the second optical transmission device, and the first optical receiver receives the second multiplexed light and the first optical outputter detects the second OSC light demultiplexed from the second multiplexed light in the first optical transmission device, the first optical transmission device and the second optical transmission device determine that a communication link between the first optical transmission device and the second optical transmission device is established.

3. The optical transmission system according to claim 1,
wherein the first optical transmission device includes a controller that selects one of a first mode in which the first pseudo light is not output and a second mode in which the first pseudo light is output, based on setting information of the optical transmission line.

4. The optical transmission system according to claim 1,
wherein the first optical transmission device includes:
a pulse transceiver that transmits an optical pulse to the optical transmission line and receives a reflected pulse of the optical pulse; and
a measurer that measures a connection state between the optical transmission line and the first optical transmission device based on the reflected pulse.

5. The optical transmission system according to claim 1,
wherein the second optical transmission device includes a backward pumping light source that outputs, to the optical transmission line, backward pumping light propagating in a second direction opposite to a first direction in which the first signal light propagates through the optical transmission line.

6. The optical transmission system according to claim 1,
wherein the first optical transmission device includes a forward pumping light source that outputs, to the optical transmission line, forward pumping light propagating in a first direction in which the first signal light propagates through the optical transmission line.

7. The optical transmission system according to claim 1,
wherein a third optical transmission device that repeats the first pseudo light and the second pseudo light from upstream to downstream is provided between the first optical transmission device and the second optical transmission device, and
wherein the third optical transmission device activates an optical amplifier provided in the third optical transmission device when receiving information on the optical transmission line and the first pseudo light from the first optical transmission device.

8. The optical transmission system according to claim 7,
wherein the third optical transmission device includes a third optical outputter that outputs, to the optical transmission line, backward pumping light propagating in a second direction opposite to a first direction in which the first signal light propagates through the optical transmission line.

9. The optical transmission system according to claim 7,
wherein the third optical transmission device includes a fourth optical outputter that outputs, to the optical transmission line, forward pumping light propagating in a first direction in which the first multiplexed light propagates through the optical transmission line.

10. The optical transmission system according to claim 1,
wherein the first OSC light has a wavelength longer than that of the first pseudo light, and the second OSC light has a wavelength longer than that of the second pseudo light.

11. The optical transmission system according to claim 1,
wherein the first optical transmission device is connected to one end of the optical transmission line, and the second optical transmission device is connected to another end of the optical transmission line.

12. An optical transmission device connected to another optical transmission device facing the optical transmission device via an optical transmission line, the optical transmission device comprising:
an optical outputter that outputs Optical Supervisory Channel (OSC) light;
a pseudo light source that outputs pseudo light including a wavelength band of signal light; and
a transmitter that transmits multiplexed light obtained by multiplexing the OSC light and the pseudo light toward the another optical transmission device.

13. An optical transmission device that is provided between a first optical transmission device and a second optical transmission device facing each other via an optical transmission line and repeats signal light and pseudo light output from each of the first optical transmission device and the second optical transmission device from upstream to downstream, the optical transmission device comprising:
a receiver that receives information on the optical transmission line and the pseudo light;
an optical amplifier that amplifies and outputs the signal light; and
a controller that controls the optical amplifier,
wherein the controller activates the optical amplifier according to the information and controls the optical amplifier to amplify and output the pseudo light received by the receiver.
